(19) United States
(12) Patent Application Publication
(10) Pub. No.: US 2011/0202376 A1
(43) Pub. Date: Aug. 18, 2011

(54) System For Golf Reservations

(76) Inventor: Bob Rodenberg, Palm Beach, FL (US)

(21) Appl. No.: 12/945,533

(22) Filed: Nov. 12, 2010

Related U.S. Application Data
(63) Continuation-in-part of application No. 12/121,401, filed on May 15, 2008, now abandoned.
(60) Provisional application No. 60/977,771, filed on Oct. 5, 2007.

(51) Int. Cl. G06Q 10/00

(52) U.S. Cl. 705/5

(57) ABSTRACT

A system and method for making reservations, in particular golf tee times, utilizing the Internet is disclosed. The system provides a user with access to a reservation system of a particular location, such as a golf course. The user is able to make and confirm a reservation for an event, such as a tee time, from anywhere. The system can also employ Voice over Internet Protocol (VoIP) to enable a user to make and confirm a reservation for an event by dialing a local phone number.

### RELATED APPLICATIONS

The present application is a continuation-in-part of U.S. patent application Ser. No. 12/121,401, filed May 15, 2008, entitled, “SYSTEM FOR GOLF RESERVATIONS”, which application in turn claims priority under 35 U.S.C. 119(e) of U.S. Provisional Application Ser. No. 60/977,771, filed on Oct. 5, 2007, and entitled, “VoIP & INTERNET WEB PAGE TEE TIME RESERVATIONS” the entirety of which are incorporated herein by reference.

### FIELD OF THE INVENTION

The present invention relates to systems and methods for obtaining reservations for particular events. More specifically, the present invention relates to a system and method for obtaining reservations for tee times at golf courses.

### BACKGROUND OF THE INVENTION

Reservations for playing golf at specific golf courses have been a time consuming and inconvenient matter for individuals. Normally reservations are made on a first-come first-served basis. Thus, the individual or individuals must go to the clubhouse at a particular golf course to make a reservation to play golf on a specific day and at a specific time. This is very inconvenient for many individuals with full time jobs or those who do not have ready access to the golf course. For example, an individual may be planning a vacation or business trip to another location and desire to play golf with friends or business associates at this other location. The only possible way to make a reservation for a specific tee time, in this situation, would be to phone the golf course and hope that they record and honor the reservation. There is no assurance, other than a verbal assurance, that the reservation the individual has requested has actually been made and recorded. In addition, at very popular golf courses, reservations are allocated to individuals through a lottery system, wherein individuals must register in the lottery and a drawing is held at a specific time. Individuals at locations away from the golf course may not be able to register in the lotteries. In addition, in most instances the individuals must physically go to the golf course to receive their tee time.

Accordingly, there exists a need for a system and method for an individual to make a reservation to play golf at a specific golf course for a specific day and time. In addition, there exists a need for the individual to receive a confirmation of the reservation other than a verbal confirmation.

### DESCRIPTION OF THE PRIOR ART

U.S. Pat. No. 5,596,636 discloses a device for making reservations for tee times at a specific golf course. The device or “Teephone” is connected to a conventional touch-tone phone line. The “Teephone” can dial and connect to automated reservation systems at golf courses. An individual desiring a tee time reservation programs the “Teephone” with the phone number of a specific golf course and the tee time or times desired. The “Teephone” will call the golf course automated reservation system at a specific time and submit the requested tee time reservation. If the reservation is made, a confirmation is displayed on a screen on the “Teephone”. This device does not enable an individual to see all of the tee times that are available on specific days. Many individuals have flexible schedules and are able to play golf at times other than their preferred time or first choice.

U.S. Published Application No. 2008/0120157 discloses a golf course tee-time management system which includes a server coupled through the Internet to a plurality of participating golf facilities. Each participating golf facility has interface software coupling the golf facility to the server. The server and the interface software are designed to provide tee-sheets in real time for each of the plurality of participating golf facilities.

U.S. Published Application No. 2002/0095319 discloses a system for marketing services that may be reserved by customers. The customers can make the reservations through a number of different communication systems and interfaces. The reservations are managed in a transaction database using time-span algebra.

U.S. Published Application No. 2001/0037225 discloses a browser-based tee time posting system for use by golf courses to post available tee times to a tee time reservations hub for reservation by golfers accessing the hub. The system includes a hub web server adapted to serve web pages and to accept time slot information from a golf course user via a browser.

U.S. Published Patent Application No. 2006/0184398 discloses a card reservation settlement system via telephone acceptance for card settlement in travel, teleshopping, and other telephone reservations. The system includes reservation reception means of a reservation receiver and the like, receiving a reservation made by a reservation transmitter, card information transmission means for transmitting information required for a card settlement to a card company, crosscheck response means of the card company, and reservation completion means of the card company.

U.S. Published Patent Application No. 2006/0089845 discloses a golf course management system for managing administrative information including: member information, a golf service manager for managing golf services using the member information, an auxiliary service manager for managing auxiliary services, the auxiliary service manager being linked with the golf service manager to handle golf services and auxiliary services together, and a system manager for managing the golf course management system using information obtained from the administration manager, golf service manager and the auxiliary service manager.

Accordingly, there exist a need for a system and method for an individual to make a tee time reservation to play golf at a specific golf course and be aware of all the different tee times which are available prior to making the reservation.

### SUMMARY OF THE INVENTION

A system and method for making reservations, in particular golf tee times, utilizing the Internet. The system provides a user with access to a reservation system of a particular location, such as a golf course. The user is able to make and confirm a reservation for an event, such as a tee time, from anywhere. The system also employs an integrated Voice over Internet Protocol (VoIP) to enable a user to make and confirm a reservation for an event by dialing a local phone number.

Accordingly, it is an objective of the instant invention to provide a system for making reservations for events using the Internet.

It is a further objective of the instant invention to provide a system for making reservations for an event utilizing a phone and Voice over Internet Protocol (VoIP).

It is yet another objective of the instant invention to provide a system for making reservations located in a central location and connected to a plurality of diverse locations at which a plurality of different events will occur.

It is a still further objective of the invention to enable a user to make a reservation over the phone at a distant location without having to dial a long distance phone number or a toll free number.

It is still a further objective of the invention to enable a golf course or other venue to utilize an automated reservation system without having the expense of the hardware and maintenance associated with an in-house system.

It is still yet another objective of the invention to enable a golf course or other venue to utilize an automated reservation system which can include a plurality of work stations positioned at various locations on-site of the golf course or other venue without the need for a LAN (local area network).

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a block diagram of the operating system of a first embodiment of the present invention;

FIG. 2 is a web page for making an online reservation;

FIG. 3 is a web page indicating the dates and times available for an online reservation;

FIG. 4 is a web page indicating a specific reservation which a user has made;

FIG. 5 is a web page wherein the players names of a group for a reservation are entered;

FIG. 6 is another example of a web page wherein the players names for a group are entered;

FIG. 7 is a web page indicating all the reservations that have been made for a user;

FIG. 8 is a web page indicating the golf scores of a user;

FIG. 9 is a web page indicating other events occurring at a particular golf course or other venue;

FIG. 10 is a web page for entering specific information for a user;

FIG. 11 is a block diagram of the operating system of another embodiment of the present invention; and

FIG. 12 is a block diagram of the operating system of the prior art.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

The present invention is directed to a system or business for making reservations for golf games or other events which reduces the user's inputs to a common interface which is relayed to various venues at different geographic locations. In particular, the present invention enables a user to contact a plurality of golf courses located at various geographical locations. The users are connected to a central server via the Internet. The central server enables players or user to make reservations for tee times for golf games without having to go to or call specific golf courses. The user can connect to the central server using the Internet or a public telephone system. In addition to golf games, reservations can be made for other events such as sporting events, concerts, movies, restaurant or any event wherein reservations are accepted.

When a user desires to make a reservation for a tee time at a particular golf course, they will log onto their computer or terminal 10 wherever they are. The user can be at home or anywhere they can obtain Internet access through an Internet Service Provider (ISP). With a laptop computer and wireless Internet service, the user can be at any location around the world. The various Internet connections are sent through a router 12 to a central server 14. The various golf courses or other venues which accept reservations for upcoming events are also connected to the router through the Internet. A database 16 stores all the necessary information required to make the reservation. Once the reservation is made, the server 14 contacts the particular golf course or other venue and sends them the information regarding the reservation or reservations. The golf course can then confirm the reservation in their on-site system and send a confirmation back to the user. The golf course can also utilize this system to confirm the cancellation of a tee time or other event.

The user may change or cancel the reservation at any time prior to the actual tee time or other reservation. This permits the golf course or other venue to allow other users or individuals to reserve the cancelled tee time or cancelled reservation. Certain golf courses or other venues may impose certain conditions regarding the cancellation or rescheduling of reservations. These conditions can be stored at the central database 16 or sent to the user from the specific golf course or other venue.

Another feature of the present invention is that a plurality of workstations or kiosks can be placed at various locations at a particular golf course, country club, restaurant, etc. The various workstations or kiosks enable an individual to log onto the system to check the information pertaining to them. The various locations also enable employees of the golf course, country club, etc. to log onto the system to process the reservation requests. Since the system utilizes the Internet, a LAN (local area network) is not required to link the workstations or kiosks.

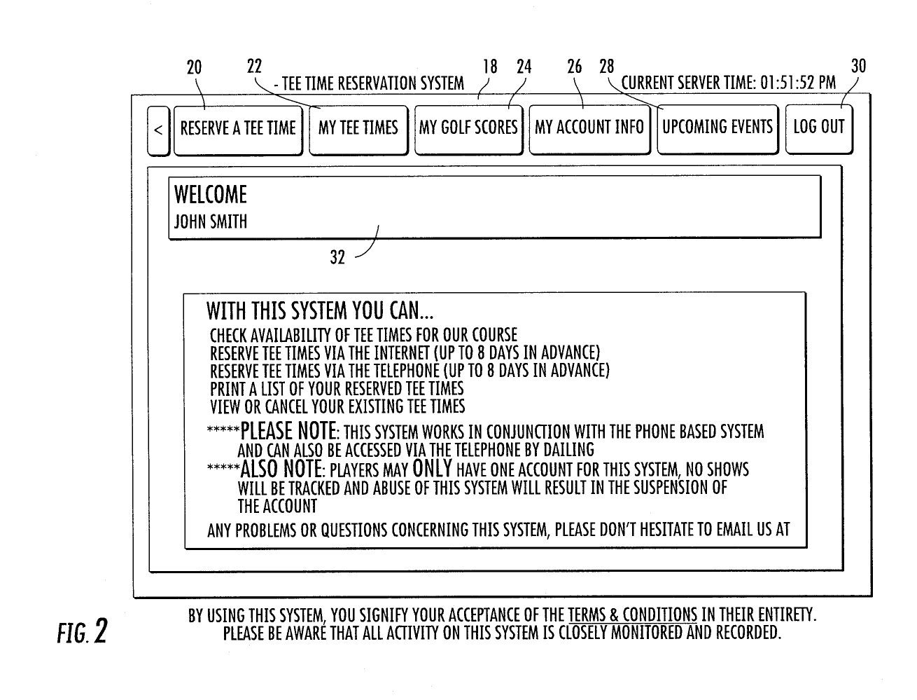

The central server 14 will preferably provide a Graphical User Interface (GUI) for a user to readily make their reservation. In a preferred embodiment the user will access a particular golf course or other venue over the Internet. They can then click on a link which connects them to the reservation system of the present invention. Next, the user will enter their e-mail address and password to gain access to the system. FIG. 2 is an example of a GUI that will be presented to a user upon registration with the system. At the top of the web page there is a menu 18 that enables the user to select which transaction they desire. For example, they can make a reservation for a tee time by selecting the “Reserve a Tee Time” button 20. They can also view a record of the tee times that they currently have reserved by selecting the “My Tee Times” button 22. They can view their past golf scores by selecting the “My Golf Scores” button 24. They can check or change their account information by selecting the “My Account Info” button 26. They can check for upcoming events by selecting the “Upcoming Events” button 28. Finally, they can log out of the system by selecting the “Log Out” button 30.

Below this menu is a banner 32 which indicates the user's name. Below this is a plurality of choices or links which enable a user to perform various tasks. The first choice enables a user to check on the tee times which are currently available. The next choice enables the user to reserve a tee time or make a reservation for an event over the Internet. In the embodiment illustrated, the particular golf course will only reserve a tee time 8 days in advance. The next choice enables the user to make a reservation using a telephone. This will be described herein after. The next choice enables the user to print a list of the tee times which they have currently reserved. The final choice enables the user to view or cancel their reserved tee times. This web page also provides a phone number the user can call to make a reservation.

In the event that there is a plurality of golf courses at a single location, the system can be programmed to select the golf course which offers the individual a tee time closes to his/her request. The system can also be programmed to prioritize the tee times based on a particular golf course selection. Also, if an individual or company owns or operates a plurality of golf courses or other establishments, such as restaurants, and they are located within a given area, for example a 5 mile radius, all of the golf courses, restaurants, etc. can be linked to a single account, so that when an individual desires a tee time or restaurant reservation, all of the different golf courses or restaurants will be searched to see which one can offer a time close to the time the individual desires. In addition, a plurality of owners of different golf courses, restaurants, etc. can decide to pool their resources and share one account so that an individual seeking a particular tee time or reservation has all of the golf courses, restaurants, etc to choose from with one request.

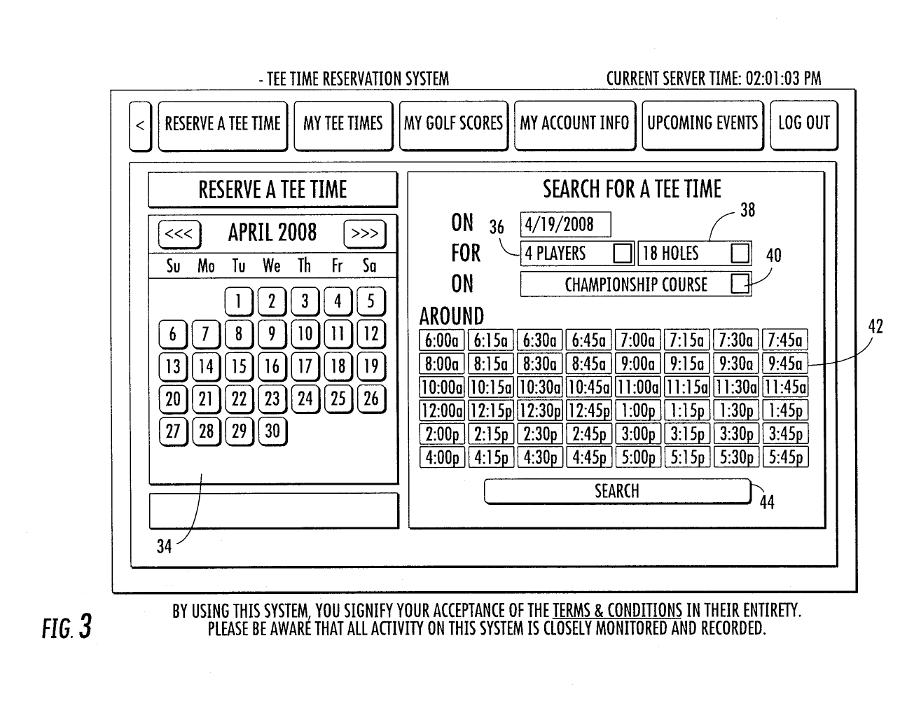

FIG. 3 is a web page which illustrates the tee times which are available. It can also display dates available for other events such as sporting events, concerts, etc. The user can select from a calendar 34 a specific day in a specific month. The available dates are usually highlighted. Once this selection is made, the date will appear on the right side of the screen. The user can then indicate in 36 if they will have 2 or 4 players. They can then select at 38 if they want to play 9 or 18 holes of golf. Next, they can indicate at 40 which course they want to play on. If only one course is available, this choice will not be available. They can then select a specific tee time from those available at 42. In certain embodiments the available tee times can be highlighted or the previously reserved tee times can be highlighted. Once the user selects a specific tee time, they will select the “search” button 44 to make the reservation.

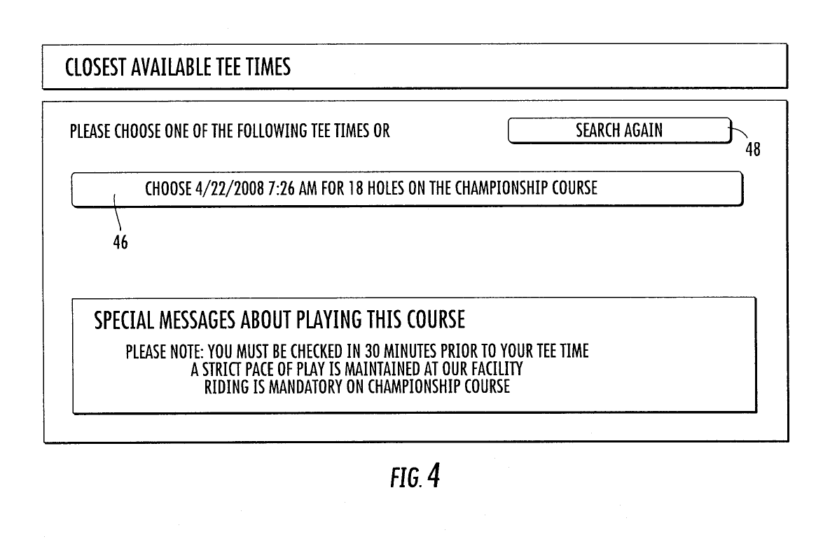

FIG. 4 is a web page which appears next. This indicates at 46 if the desired tee time is available, or indicates the next closest tee time which is available. If the user is satisfied with the tee time which is indicated they will click on button 46. If they want to make another selection they can return to the previous web page or screen by selecting button 48. This web page can also provide specific information concerning the reservation. For example, the user and their party must check in at the clubhouse or other location specified thirty minutes prior to their tee time. Another requirement is that a golf cart must be used when playing the championship course.

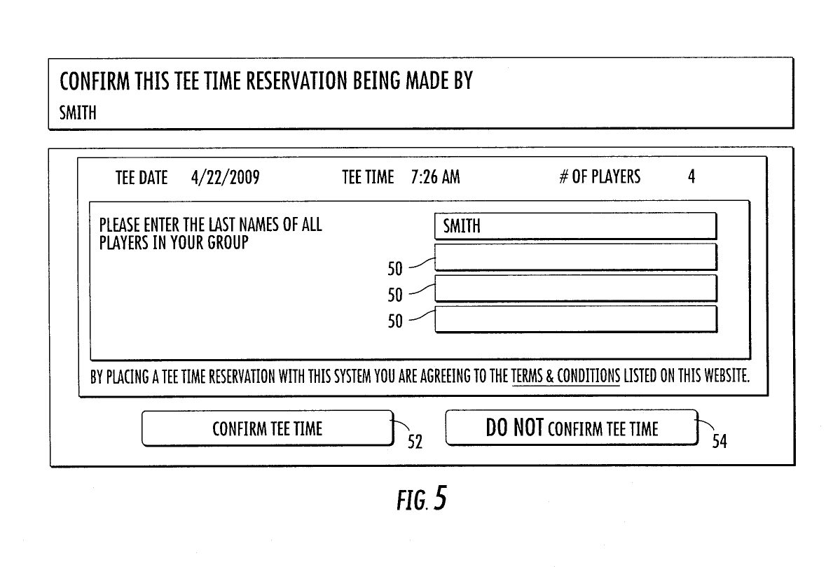

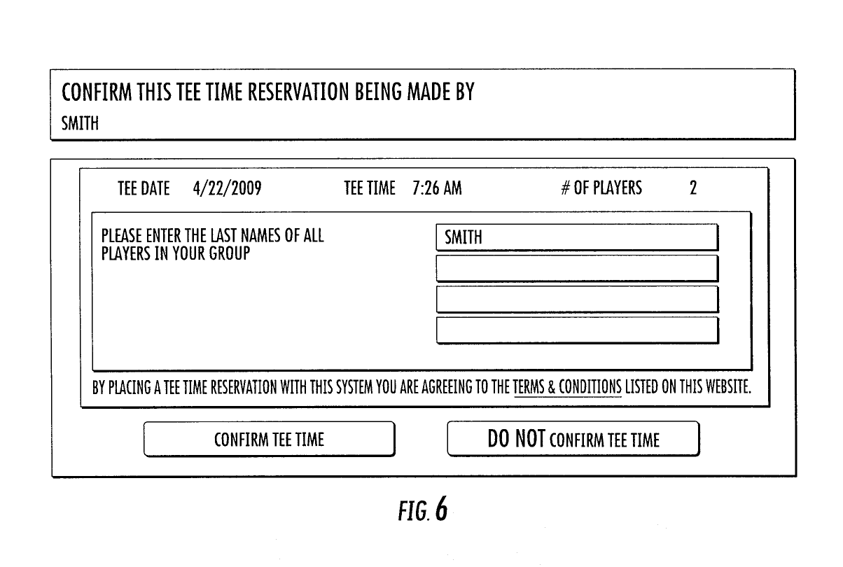

FIG. 5 is the web page or screen which appears next. On this page the user's name appears, and they will then enter the names of the other players in their group in the areas provided at 50. They can then confirm the reservation by selecting button 52 or start again by selecting button 54. FIG. 6 is a web page similar to FIG. 5 wherein there are only two players in the group.

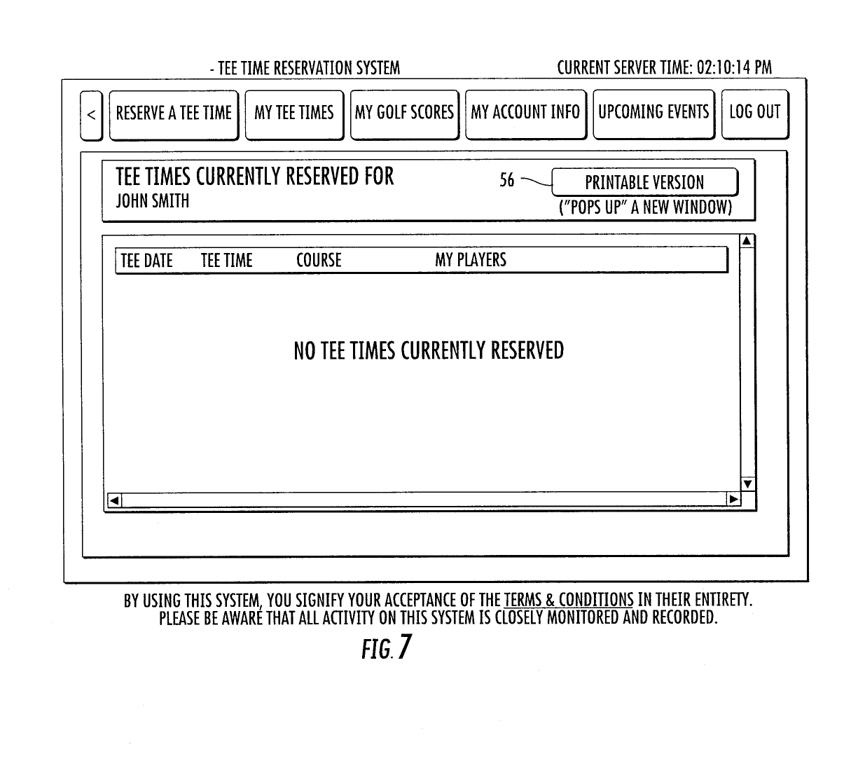

FIG. 7 is the web page or screen which appears when a user selects button 22 from the menu at the top of the screen illustrated in FIG. 2. This web page displays the dates, tee times, golf course name, and players for which the user has current reservations. The user can print out a paper copy of the reserved times by selecting button 56.

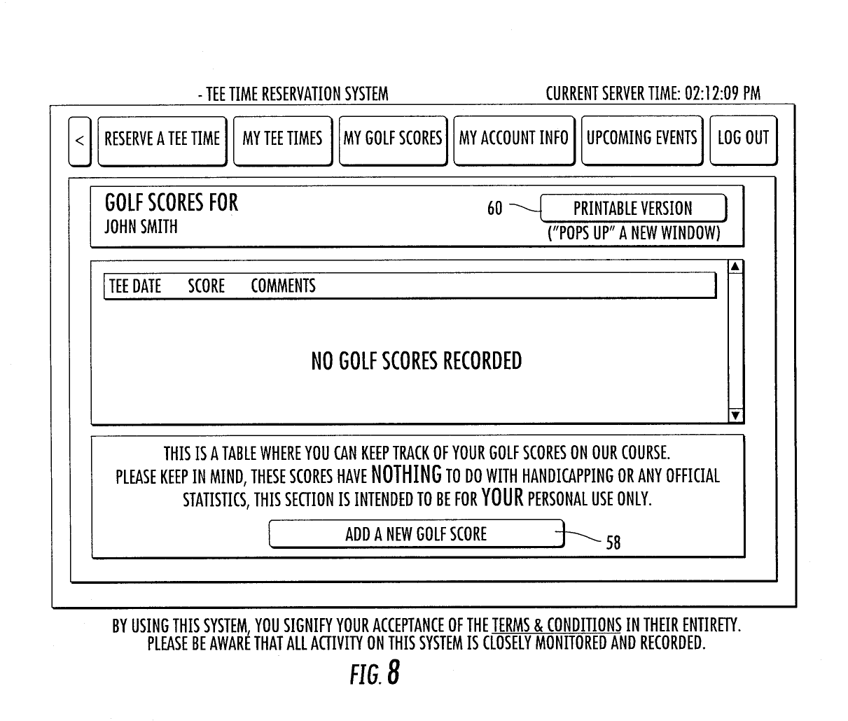

FIG. 8 is the web page or screen which appears when a user selects button 24 from the menu at the top of the screen illustrated in FIG. 2. The users past golf scores are displayed. New golf scores can be entered by selecting button 58. The user can print out a paper copy of the scores by selecting button 60.

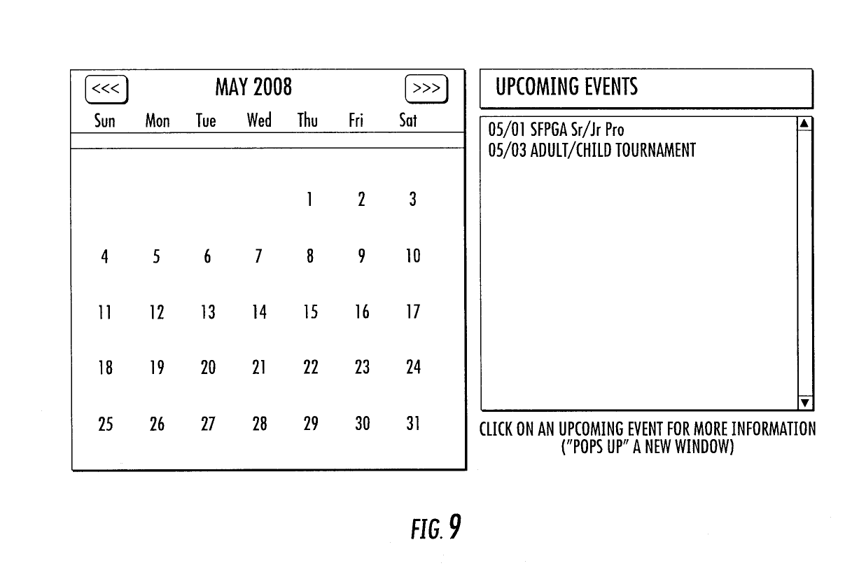

FIG. 9 is the web page or screen which appears when a user selects button 28 from the menu at the top of the screen in FIG. 2. FIG. 9 is a display of upcoming events at a particular golf course. If the user is logged onto a web site or venue for a sporting event or other event, the upcoming events at that particular venue will be displayed. This enables the user to view future sporting events, concerts, etc. The specific events illustrated on the right side of the screen can be links to the specific events. By selecting the specific event the user can obtain further information concerning the event.

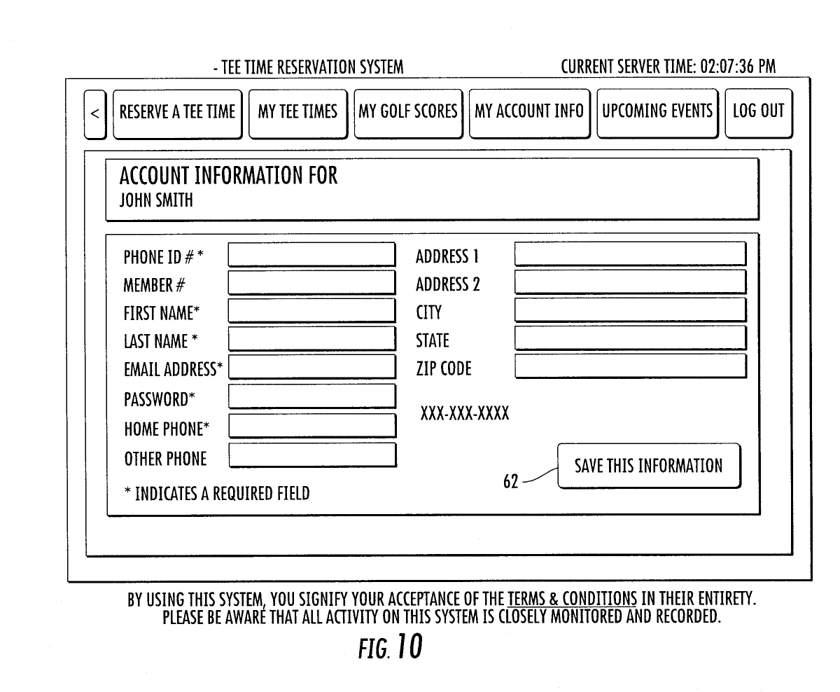

FIG. 10 is the web page or screen which appears when a user selects button 26 from the menu at the top of the screen in FIG. 2. The user can enter or change the information relating to their account at this screen. After the information is entered or changed, the user selects button 62 to save this information to the database 16 or other location established by the system. For example, all or a portion of this information can be stored at a particular golf course or other venue.

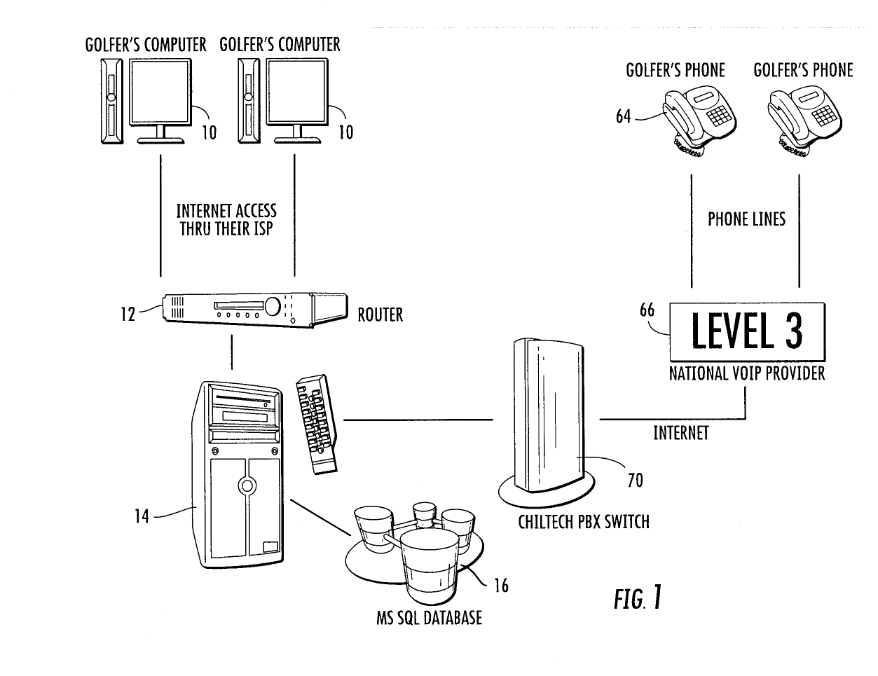

Referring back to FIG. 1, Golf tee times or other reservations can also be made over a telephone 64. The telephone 64 may also be referred to as a user terminal. The telephone 64 may be a landline phone, a cellular phone or a satellite phone. Any phone which is capable of operating with the voice recognition system employed by the invention can be used. When the user desires to make a reservation, they will dial a local phone number which connects them via a public switched telephone network, or similar system, to a voice over internet protocol (VoIP) provider 66. The local phone number utilizes DID (direct inward dialing) whereby the phone company allocates a range of phone numbers all connected to a customer's PBX. As the calls are presented to the PBX, the number that the caller dialed is also given, so the PBX can route the call to the desired person within the organization. In order for individuals connected to a traditional PSTN network to call individuals connected to VoIP networks, DID numbers from the PSTN network are obtained by the administrator of the VoIP network and assigned to a gateway in the VoIP network. The gateway will then route calls incoming from the PSTN across the IP network to the appropriate VoIP user. Similarly, calls originating in the VoIP network will appear to users on the PSTN as originating from one of the assigned DID numbers. This avoids the need for an 800 toll free number or the user having to dial a long distance phone number. They are then connected via the Internet to a telephone exchange 70. The telephone exchange 70 is connected to the server 14. The connection between the exchange 70 and the server 14 is preferably made utilizing a Primary Rate Interface (PRI) connection. Other types of connections are also possible. Once the user is connected they can enter their PIN number to access their account. Their account can initially be set up over the phone or over the Internet as previously described. Utilizing voice prompts and a touch tone phone, the user can make a reservation for a tee time or other event. The system will provide voice prompts and voice menus to guide the user through the reservation process. If the user is making a reservation for a tee time, the names of the players in the group are normally required. The user will speak their names into the phone and voice recognition software will enter this information into the database. The spelling of the names is confirmed by the voice recognition software. An operator, or the user, may have to provide the spelling of the names. In another embodiment, the employees of the golf course or restaurant will make a WAV file from the audio of the phone reservation. They can download this on a computer and analyze it for the correct name spellings. They can then enter these names into the reservation system in the proper account. They will receive a confirmation over the phone of the reservation. They can also receive a confirmation via e-mail, through the regular mail, by a text message on a cellular phone, etc. In addition to voice prompts, other voice or tone activated systems can be employed to make the reservations.

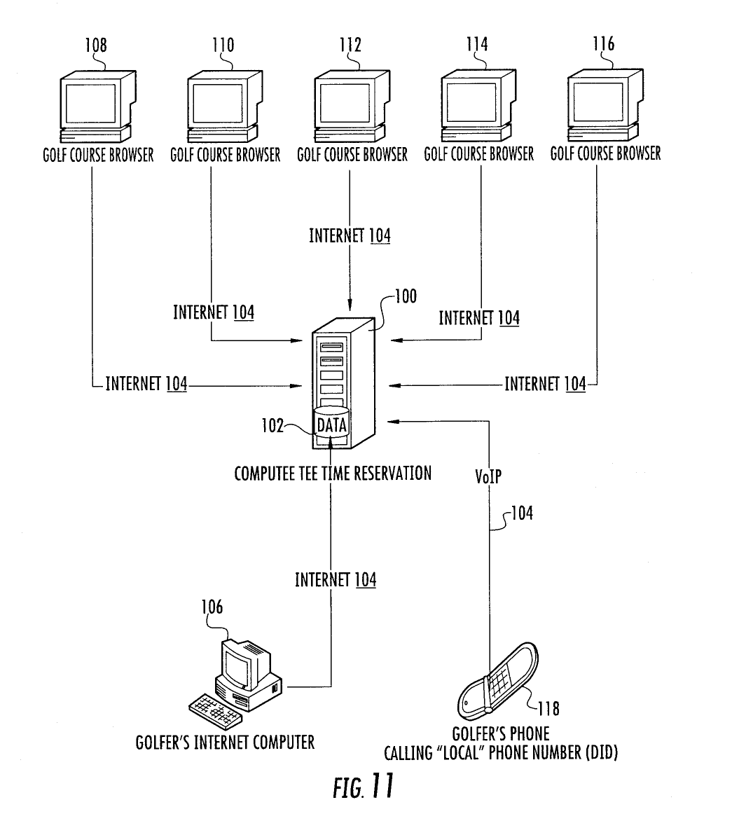

Another embodiment of the present invention utilizes a central computer with specialized software thereon located at one central location. This location can be anywhere. The current reservation systems required that one or more computers, which must be provided with specialized software, be physically located at each golf course or location at which a reservation is made. This becomes very expensive. The present invention utilizes a central computer or server 100 (FIG. 11) which includes specialized software located at one convenient location. The specialized software is installed on a hard drive 102. The hard drive also includes data regarding various golf courses, golf course requirements, tournaments, players' scores, reservations, etc. The central computer 100 is connected to other computers via the Internet 104.

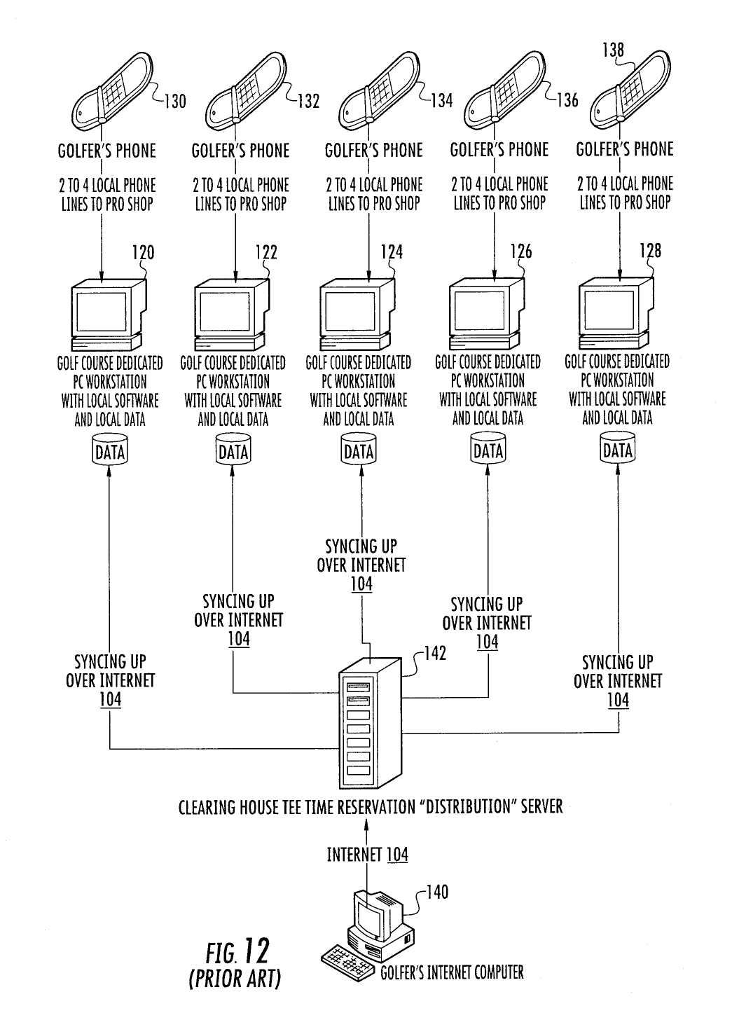

When an individual desires to make a reservation at a golf course or any other business that accepts reservations, he or she need only log onto their PC or laptop computer 106 and connect to the Internet. Utilizing a Web browser, such as Internet Explorer, Firefox, Chrome, Safari, etc., the individual can access the central computer 100 and the specialized software. The individual does not have to install any special software on their computer. This permits an individual to access the central computer and reservation system from any computer/laptop at any location which provides access to the Internet. Since only one central computer is employed, there in no need for one computer at a central location to access another computer at each place of business, to make a reservation as is required in the prior art. The prior art system is illustrated in FIG. 12.

In the prior art system, each individual location or place of business 120-128 has their own central computer which includes localized special software. The information regarding each individual location is stored at that location. This adds significantly to the cost of providing a reservation service to various businesses. Further, access to the information for each individual location may not be available if their system is down or cannot be coordinated with other reservations at different locations. For an individual to make a reservation, they must access each different location 120-128 separately and make the reservation. This can present problems if someone is trying to coordinate reservations with a number of different locations/businesses such as golf courses, restaurants, health clubs, etc. Another disadvantage of the prior art is that each computer or workstation at each place of business requires specialized software, and this becomes very expensive. When an individual wants to make a reservation utilizing the prior art system, they log onto their computer 140 and access a central computer 142 via the Internet 104. The central computer 142 acts only as a switch to direct the individual request to a specific business or location 120-128. The individual must then access the special software at one of these locations to make a reservation. The individual locations 120-128 cannot access each other so that reservations between different locations can be made and coordinated. Further, the prior art has only local phone lines, 130-138, to the various places of business so that an individual must make a long distance phone call to access the reservation system of that business.

Computers 108 at various golf courses or other places of business can also access the central computer 100 via the Internet. For example, computer 108 can be located at a golf course in south Florida, and computer 110 can be located at a golf course in South Carolina. An individual may be planning a vacation or business trip which includes south Florida and South Carolina. If the individual wants to make reservations at different golf courses in both locations during the trip, they only need to log onto a computer at their home or place of business and make the reservations at both locations. Because all of the data regarding the various golf courses is stored on a central computer in a central data bank, an individual can readily determine what tee times are available at various golf courses. That individual can then make reservations based on that information.

The present invention is especially useful when another person is making reservations for an individual. For example, if an individual is planning a business trip and wants to play golf with various customers in different locations during the trip, the individual's executive assistant can make the reservations at the golf courses from their computer. They would not have to access their boss's computer or any other special computer.

In addition to golf courses, restaurants 112, health clubs 114, etc. can access the central computer 100 via the Internet. An individual making reservations can now have access to various business and locations. This would enable them to coordinate golf tee times, meal times and health club times with one simple log on to the Internet. Since the various businesses also have access to the central computer 100 via the Internet, they can check their reservations at any time. They can also make changes to available reservation times on a daily basis without having to access special computers or specialized software.

In addition to utilizing computers and the Internet to make reservations at various locations, individuals can access the central computer by phone utilizing voice over internet protocols (VoIP). Each of the various locations 108-116 has its own local Direct Inward Dialing (DID) phone number. This enables each location or business to provide touch tone reservation systems (Interactive Voice Response—IVR) at little or no expense. This is because only one dialogic card is required at the central computer 100, rather than at each of the individual computers 120-128. This system enables an individual to book a tee time or make a dinner reservation form anywhere at any time. For example, if some one wanted to make a lunch reservation while they were on a golf course, they could do so by using their cell phone and the IVR system of the present invention. Reservations can also be made at the office, while shopping, on a boat, etc.

The present invention further provides simultaneous touch tone phone and computer Internet reservations. This is achieved by the use of one central computer or server 100 on which all the data is stored. The central computer 100 is also provided with a dialogic card which enables the use of touch tone phones to make reservations.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A reservation system for implementing real time access to a plurality of individual, diverse locations, said system comprising:
a user terminal;
a first communication interface connecting said user terminal to a central computer, said central computer having specialized software thereon;
a reservation system, said central computer operatively connected to said reservation system;
said reservation system operatively connected to a plurality of different venues by a second communication interface, said reservation system providing said user with access to a plurality of events;
said user terminal constructed and arranged to enable said user to view and select one of said plurality of events;
said reservation system communicating a confirmation of said user selection to said user terminal through said communication interface.

2. The system of claim 1 wherein said first and said second communication interfaces are the Internet and said user terminal both transmits data and receives data.

3. The system of claim 2 wherein said terminal includes a graphical user interface.

4. The system of claim 1 wherein said reservation system includes a server, said server is in communication with at least one of a plurality of different venues, said different venues are located at the sites of said available events;
said reservation system further including a database connected to said server.

5. The system of claim 4 wherein said database of reservation system contains information including at least one of a reservation time for an event, all of the reservations relating to said user and said user's scores in a game.

6. The system of claim 4 wherein said reservation system includes information including at least one of a reservation time for an event, all of the reservations relating to said user and said user's scores in a game, said information is stored at said different venue.

7. The system of claim 5 wherein said information is a reservation time for a golf game and said user's scores are golf scores.

8. The system of claim 1 wherein said user terminal is a telephone, said second communication interface is a public switched telephone network and the Internet, said user terminal both transmits data and receives data.

9. The system of claim 8 wherein said telephone communicates with said reservation system using Voice over Internet Protocol (VoIP).

10. The system of claim 9 wherein said central computer simultaneously communicates with said user and said different venues utilizing both said first and said second communication interfaces.

11. The system of claim 8 wherein said second communication interface includes a telephone switch, said telephone switch connects the Internet to said server.

12. The system of claim 11 wherein said central computer simultaneously communicates with said user and said different venues utilizing both said first and said second communication interfaces.

13. The system of claim 8 wherein a voice activated communication system is connected to said server, said voice activated communication system accepting input from said user and converting said input to usable data in said server.

14. The system of claim 13 wherein said central computer simultaneously communicates with said user and said different venues utilizing both said first and said second communication interfaces.
